(19) United States
(12) Patent Application Publication
(10) Pub. No.: US 2021/0258414 A1
(43) Pub. Date: Aug. 19, 2021

(54) THE WIRELESS CONFIDENTIAL DEVICE FOR VOICE COMMUNICATION

(71) Applicants: Oleksandr Vasyliyovych NESTERENKO, Boyarka Kyiv region (UA); Roman Petrovych SAKUN, Kyiv (UA); Yaroslav Volodymyrovych ROMASHKO, Kyiv (UA); Kostiantyn Petrovych SHEVCHENKO, Kyiv (UA); Volodymyr Viktorovych KHYLIUK, Kyiv (UA); Andriy Volodymyrovych LEVCHUK, Kyiv (UA)

(72) Inventors: Oleksandr Vasyliyovych NESTERENKO, Boyarka Kyiv region (UA); Roman Petrovych SAKUN, Kyiv (UA); Yaroslav Volodymyrovych ROMASHKO, Kyiv (UA); Kostiantyn Petrovych SHEVCHENKO, Kyiv (UA); Volodymyr Viktorovych KHYLIUK, Kyiv (UA); Andriy Volodymyrovych LEVCHUK, Kyiv (UA)

(21) Appl. No.: 16/972,986

(22) PCT Filed: Jun. 8, 2018
(86) PCT No.: PCT/UA2018/000057

§ 371 Date: Dec. 7, 2020

(51) Int. Cl. H04M 1/19; H04M 1/05; G10K 11/178; H04M 1/60; H04R 1/10

(52) U.S. Cl. CPC H04M 1/19; H04M 1/05; G10K 11/17861; G10K 2210/1081; H04R 1/1041; G10K 11/1781; H04M 1/6066

(57) ABSTRACT

The present invention is directed to a wireless confidential device for voice communication that has an ergonomically shaped housing with a flange, the shape of which reflects a covering area around a user's mouth. The housing further has at least one microphone, transceiver, switch, sound absorbing means. The sound reducing means can include a front portion, side portions and back portion. The flange is located on the inner surface of the front part of the housing. The device also has a wired or wireless headset, at least one headphone connected with the mobile communication means, and arranged to complement the passive muffling methods of speech by active muffling methods of speech and noise reduction techniques.

### CROSS REFERENCE TO RELATED APPLICATIONS

This application is a national stage of International Application No. PCT/AU 2018/000057, which was filed on Jun. 8, 2018, and which is herein incorporated by reference.

### BACKGROUND

The present invention relates generally to wireless communication, and more particularly, to devices and means for ensuring confidentiality of conversation using an electronic communication device, such as mobile phone, cellular, landline and other communication devices with microphones. Privacy of conversation is relevant for various public places, including restaurants, cinemas, public transport, offices, etc. At the same time, often it becomes important to conduct a confidential conversation that is inaccessible to the attention of others, as well as the possibility of communicating with the interlocutor without sound and/or noise interferes, where the carrier of that can be an environment.

With the development of mobile and cellular communications, there is a consequent need to maintaining confidentiality of conversation during using a mobile or cellular phone in public places. The wide variety of telephone-microphonic headsets used with mobile and cell phones in various areas of public life partly solve this problem. However, telephone-microphonic headsets can protect from listening only incoming information by the outsiders or outgoing people, while content of outgoing information can be publicly available.

All known telephone-microphonic headsets contain a telephone capsule and a microphone necessarily. The air conduction microphone is usually used, placed with a flexible cable directly near the user's mouth, which causes an increase in the level of reception by the microphone of extraneous signals and noises, especially when using differential-type microphones.

There are known from the prior art masks and other auxiliary communication devices equipped with a microphone. For example, a telephone-microphonic headset known under Switzerland Patent No. 681841, the date of publication 1995 year, discloses a headphone with a phone and a microphone of the ling phone type arranged on the cervical collar. The headphone designed in the form of an ear element, the flat part of which allows to be placed in the auricle, while the headphone and the microphone are connected by cable through the connector to the mobile. The disadvantage of this design is that it does not the device, in which the user can speak without being heard by others.

Another mask is disclosed in Russian Federation patent No. 166740 for utility model, publication date Oct. 12, 2016 year. The mask cover the lower part of the face. The mask include installed microphone in the mouth area and headphone made in the form of an ear element, the flat part of which allows it to be placed in the auricle. In this, the mask is made of a resilient material, which makes it possible to take shape on the face of the user in accordance with the configuration of the user's face. The mask has an edge made of soft, non-aggressive sealant to the skin; it can be made of sound-absorbing material and can be connected to a mobile using Bluetooth technology. The main disadvantages of this design is the ability to muffle the user's speech only passively by using material that muffles the sound or reduces sound. There are no means that could analyze the level of external noise and protect the user's speech from it.

The closest analogue is the wireless voice muffled device for mobile communication on United States application No. US 2008/0195390 A1, published on Aug. 14, 2008 year, comprising a housing with a closed end and a wide-open end. The closed end of the housing has ergonomic shape; easy-to-use. The wide-open end of the housing is shaped to cover the area of the face around the user's mouth. The housing further comprising a microphone, a transceiver, anti-bacterial or sound absorbing means, or means for reducing sound, a switch and a venting hole. This device has several close embodiments and is quite effective tool for voice recognition, passive muffling of undesirable extraneous vocal sounds, creating comfortable conditions for conducting confidential conversations in public places. In addition, this device prevents the increase of noise in public places, which can lead to conversations on mobiles without muffling. The main disadvantages of the closest analogue are the use of only passive methods of speech muffling and the lack of additional tools that could analyze the level of external noise in public places and protect the user's speech from him.

It must be noted that the use of wireless technologies such as Bluetooth, WIFI, WiMAX, wireless USB or other suitable wireless radio frequency transceiver in the developed devices have a great influence on the possibility of effective noise reduction, the ability to conduct confidential negotiations, and the delivery the clarity of vocal sound in microphones.

The aim of the invention is to create a device that can provide, by means of active electronic components, the confidential communication using mobile communications, substantially reduce the noise level created in a conversation using mobile communications in public places, using Bluetooth or similar wireless systems and technology for the transmission of audio signals to communication facilities and telecommunications devices, effectively eliminate the effect of external noise on the level of audio signals supplied to the microphone input.

The aim is achieved by the wireless confidential device for voice communication comprising an ergonomically shaped housing with a flange shaped for covering the area around the user's mouth, also the housing comprises at least one microphone, transceiver, switch, sound absorbing mean or a sound reducing mean, wherein the said housing comprising a front portion, side portions and back portion, the flange is arranged on the inner surface of the front part of the housing, the device includes a wired or wireless headset, at least one headphone connected with the mobile communication means, and arranged to complement the passive damping methods of speech by active damping methods of speech and noise reduction methods.

Further the front part of the housing is made detachable and the flange on the inner surface of the front part of the housing is made removable and from an elastic sound-absorbing material or a material that reduces sound. It is desirable to use materials that are neutral to the skin of the user and provide a tight comfortable fit to the skin. Using materials with the above properties will allow passive muffling of sound level, which can also lead to the desired noise reduction. Such materials are easily cleaned and easily disinfected.

Further the headphone is made in the form of an ear element, the flat part of which allows placing it in the auricle.

Methods of passive speech muffling are based on the design features of the wireless confidential device for voice communication and the effectiveness of these methods directly depends on the characteristics of the materials used in the production of this device: the degree of sound absorption or the degree of sound reduction.

Methods of active speech muffling can be an active complement to passive muffling methods and used as a protective sound background outside the device. As a repeater of a protective sound background, as a rule, are used the dynamics which included in the mobile communication means, however, in some embodiments the device can comprises with at least one external speaker used for retransmission of a protective background sound. In other words, active muffling methods implement active masking or an active way of protecting conversation privacy using mobile communication means when a noise screen—a protective background sound, the level and intensity of which the user can adjust during a conversation with the device, protects the user's speech. Also, in some embodiments of the device, an external speaker connected through a Bluetooth system can also perform the function of a background audio translator, which can lead to a significant reduction in the weight of the device—in fact, up to the size of a standard telephone headset.

Moreover, the wireless confidential device for voice communication van be controlled by using special software loaded into mobile communication means. With the software, the user has the opportunity to select different modes for creating a sound background. For example, a protective sound background can be formed based on a set of standard sounds recorded in the memory of a mobile phone or mobile communication means. Such background sounds throughout the user's conversation, including pauses in the conversation. In addition, the mode of the protective sound background can be implemented in the form of a secondary audio signal sounded in unison with the user's speech in the form of spoken words. This mode makes the user's speech incomprehensible even for people who are very close to the talking person who uses the device.

Preferably the housing can be equipped in addition with at least one external microphone connected to the transceiver and configured to measure the noise level outside the device that can greatly affect the quality and purity of the audio signal input to the input of the main microphone during the conversation to enable effective noise reduction in public places. Based on the data obtained by such a microphone, it is possible to activate the operating mode of the device associated with reduction of external noise. It is important to note that active noise reduction mode is possible only when using a sound background based on a set of standard sounds. The essence of reduction of external noise is that the sound background obtained from an external microphone acts as a primary acoustic wave, on the basis of which a secondary audio signal inverse to the primary signal (the primary acoustic wave) is created. The output signal can consist only of a secondary signal and from a combined signal the sum of the primary and secondary signals. In fact, there is a mixing of the noise background to a useful signal. The most effective suppression of external noise occurs when using a combined output signal, since such a signal leads to the creation of destructive interference acting in the area surrounding the device, which leads to significant noise outside the device, resulting in a reduction in the imposition of external noise on the user's speech. Due to these actions, subscribers of the user will receive an audio signal of higher quality.

One of the embodiments of the device is a device with a detachable housing, due to what simultaneously it is possible to solve at once several problems related with convenience of use of the device by the user. Generally, the front part of the housing is detachable, but other implementations may be available. Also unlimited are the separation options and the technical means used to implement it. Magnetic latches, special hooks, protrusions on one side and the corresponding grooves on the other side, etc., can be used. Likewise, given the fact that the device must tightly cover the lower part of the user's head, and the sizes of the heads for different users may be different, resilient and/or elastic elements can be used in the housing of the device. For example, the side parts of the housing and/or the back part of the housing may be made of resilient and/or elastic materials. For the different head sizes in the device can be provided means to change the internal dimensions. In the passive state, the device can simply lie or hang on the user's neck in the open position, which does not cause any discomfort.

### BRIEF DESCRIPTION OF THE DRAWINGS

The figures shown below, as well as the description of examples of implementation for wireless confidential device for voice communication, are given only to illustrate the claimed invention and do not limit the scope of the rights by the claims:

FIG. 1 is a general view of wireless confidential device for voice communication with a detachable housing.

FIG. 2 is a front view of wireless confidential device for voice communication with a detachable housing.

FIG. 3 is a back view of wireless confidential device for voice communication with a detachable housing.

FIG. 4 is a left view of wireless confidential device for voice communication with a detachable housing.

FIG. 5 is a right view of wireless confidential device for voice communication with a detachable housing.

FIG. 6 is a top view of wireless confidential device for voice communication with a detachable housing.

FIG. 7 is a top view of wireless confidential device for voice communication with a detachable housing.

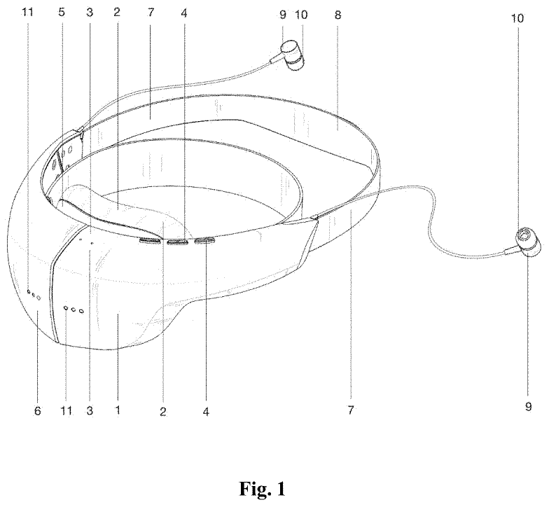

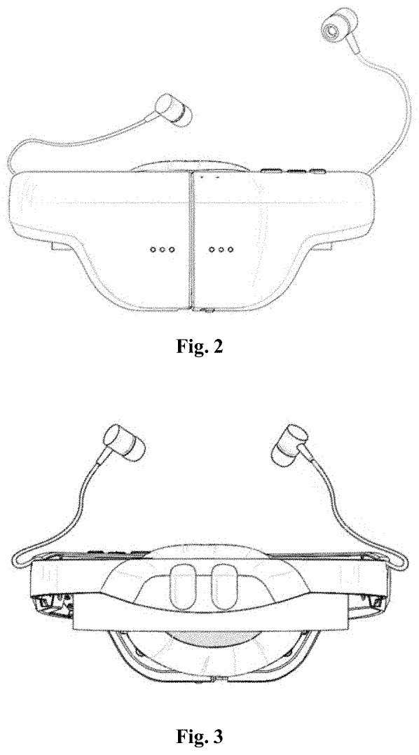

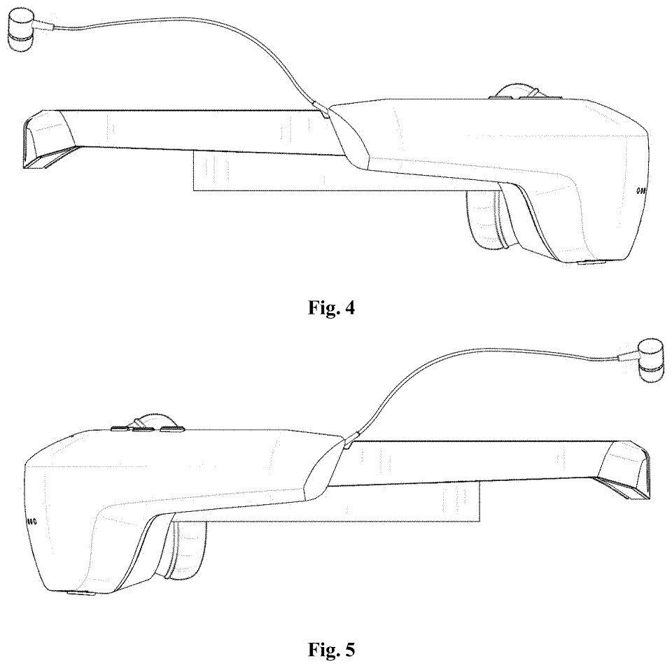

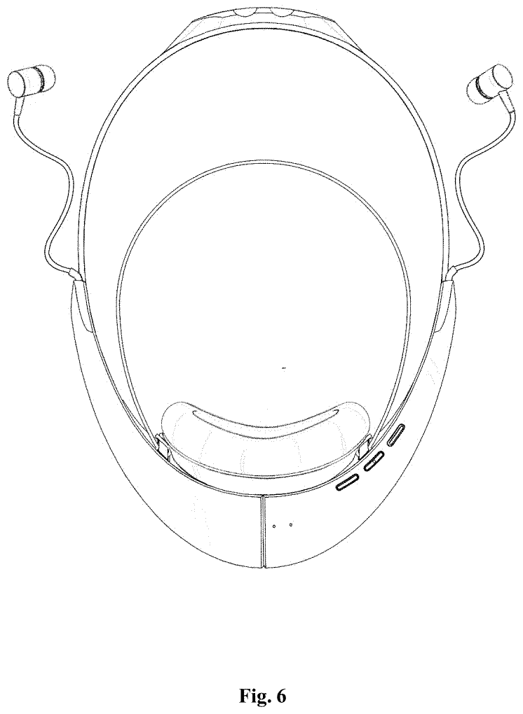

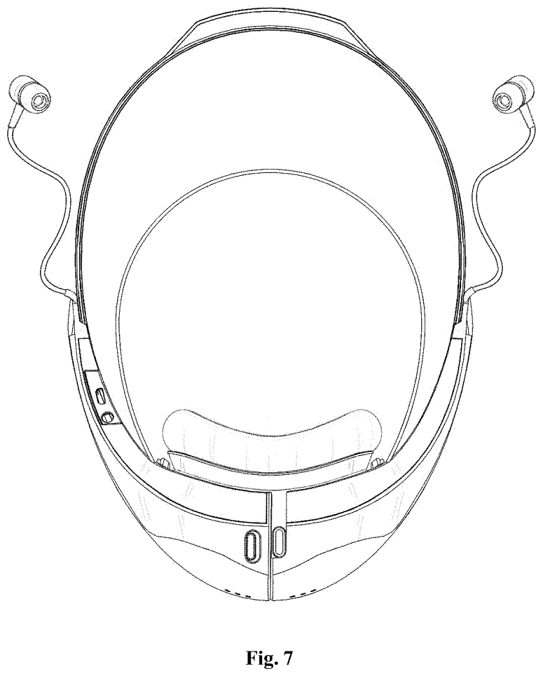

### DETAILED DESCRIPTION

s used herein, the term “housing” is intended to generally refer to a metallic or non-metallic or a combination of both, protective cover, casing, case, or shell, designed to contain, enclose or support mechanical, electrical, electronic components, and/or any combination thereof. It can be homogeneous, heterogeneous, multi-layered, multi-bodied, multi-frame, multi-colored and/or any solid.

As used herein, the term “ergonomically shaped” is intended to generally refer to a contoured mass or body that conforms or fits a user's full hand comfortably, does not slip out of the user's hand with the least amount of effort, to help reduce fatigue and awkwardness. It is also intended that the ergonomically shaped mass is a surface that has been enhanced by integrating a replaceable or non-replaceable, non-slip, natural, compressible, gripping material made of wood, rubber, plastic or leather.

As used herein, the term «switch» is intended to generally refer to a push button switch. This term has recently been widely adopted by most Bluetooth wireless headset manufacturers. Said switch provides the power up, pairing, microphone activation, power down, as well as other special cellphone wireless headset functions. This switch in most instances has imbedded small indicator lamps, which provide the status information of the headset.

As used herein, the term «transceiver» is intended to generally mean an electronic device or circuit that transmits and receives analog or digital signals. It comes in many forms; for example, a transponder on a satellite, a network adapter in the computer or the circuits in a cellphone. One example is the Bluetooth transceiver unit, which typically consists of electronic circuits such as codecs, audio to digital converters, digital to audio converters, RF and AF amplifiers, flash memory or ROM, internal memory, or RAM, RISC or CPU, automatic shut-off timer, self-test circuitry, and other associated electronic components. Further, the term «module», refer to a self-contained assembly of electronic components and circuitry, such as a stage in a computer that is installed as a unit. Therefore, as used herein, the term «transceiver unit» or «transceiver module», is intended, but not limited, to generally refer to an integrated assembly having electronic components and circuitry such as a transmitter, receiver, antenna, voice processing, voice conditioning, voice recognition, sound quality optimization, power supply, battery, digital and analog processors, signal conditioners and/or any combination thereof. It should be further understood that it is a common practice in the electronics industry to use expansion slots, adapters, sockets, connectors, and/or any combination thereof, with the goal of providing robustness and extensibility by adding enhancements and new functionalities of their hardware products. An example of this is the PC's modem whereby they have now been integrated into the PCs CPU instead of being an external device with its own power supply. Likewise, this paradigm as is plainly evident works true in reverse. Using the aforementioned model, therefore, it should be understood that some of the components of the transceiver module does not have to stay enclosed inside the module to meet the legal definition but rather some components can also be located outside thereof. For example, to lengthen the transceiver's usage, a battery pack can be added, and to extend its range a RF amplifier and longer antenna can be added, externally. Further, due to the rapid advances in the semiconductor industry concerning miniaturization, it is further understood that more and more discrete components are being integrated and made modular therein. For example, a decade ago, most PC practitioners refer to the CPU as generally consisting of discrete components such as a CPU chip, digital communications controllers, I/O controllers, firmware ROM, timing circuits, cache controller, etc. Nowadays, the CPU refers to all the components in a motherboard that have been integrated so tightly into almost a single module or unit, allowing them to be installed in a new breed of PC called the Mobile Internet Device (MID).

The wireless confidential device for voice communication comprises an ergonomically shaped housing 1 with a flange 2, the shape of which is suitable for covering the area around the user's mouth. Additionally the housing 1 comprises at least one microphone 3, a transceiver (not shown), a switch 4, sound-absorbing means or a sound-reducing means 5. The housing 1 includes a front part 6, side parts 7 and a back part 8. Wherein, in various embodiments, the housing 1 can be made in as a single structure or as a composite structure, i.e., in the form of connected to each other: the front part 6, side parts 7 and a back part 8. The housing 1 can be embodied in the form of a detachable or one-piece construction. The detachable elements of the housing 1 can be any of the parts, including the front part 6, the side part 7, the back part 8 or any combination thereof. If the housing formed as the detachable construction then the connecting elements of the housing parts 1 can be any type. On the inner surface of the front part 6 of the housing 1 is arranged the flange 2, which can be of any suitable shape. The switch 4 can be implemented as automatic electronic means with function on/off of the device or in the form of a manual switch. The housing 1 further comprises at least one external microphone (not shown) connected to the transceiver and configured to measure the noise level outside the device. In addition, the device comprises a wired or wireless headset 9, with at least one headphone 10 made in the form of an ear element, the flat part of which allows it to be placed in the auricle. For the convenience of the device in the housing 1, special air channels 11 can be made. In addition, the housing 1 can comprise at least one external speaker 12.

The claimed device functions as follows. When the device not activated, it can be near to the user or be hanging on the user's neck, which does not cause any discomfort. In addition, the device can be used as a mobile speaker, through which it is convenient to listen to music or receive audio information. To activate the device, the user uses the switch 4, implemented as electronic means of automatic turning on/off of the device or as a manual switch. With this switch 4, the user can also select the desired mode of operation. Before the device starts working on the incoming or outgoing call from the caller, the user places the device so that the flange 2 of the housing 1 conveniently covers the area around the user's mouth. The use of special materials for the inner shell of the housing 1 that are neutral to the user's skin provides a comfortable fit to the skin. By default, one of the possible modes of operation of the device can be set:
mode of operation with passive sound muffling (without creating an external protective sound background), is possible due to the properties of the materials from which the flange 2 and the inner shell of the housing 1 are made;
the mode of creating an external protective sound background based on a set of standard sounds recorded in the memory of a mobile or mobile means of communications;
mode of interactive formation of a sound background based on a user's speech with the formation of a secondary audio signal and overlapping it on a primary audio signal;
active noise reduction mode, which is a particular case of the mode of creating an external protective sound background based on a set of standard sounds and additionally ensures the purity of the outgoing acoustic signal.

The mode of operation of the device with passive sound muffling is the least efficient mode, since the quality of the sound muffling directly depends on the level of the output sound signal (the volume of the user's speech) and the sound-absorbing properties of the flange 2 and the housing 1 (its inner shell). Despite the low efficiency, this mode of operation is the most convenient, both in terms of easy use by the user, and in terms of easy manufacturing.

Each of the possible modes of active muffling of sounds has its advantages. For example, mode of interactive formation of a sound background based on a user's speech with the formation of a secondary audio signal and overlapping it on a primary audio signal may comprise an output signal consisting only of a secondary signal inverse to the primary signal, and also from a combined signal representing the sum of the primary and secondary signal. The transmission of such an output sound signal through the external speaker of the device and/or through the external dynamics of the mobile or mobile communication means to the environment surrounding the user makes the user's speech incomprehensible even for people who are very close to the speaking through the device user.

The mode of creating an external protective sound background based on a set of standard sounds recorded in the memory of a mobile or mobile means of communications is perhaps the most effective mode of ensuring the confidentiality of conversation and a means of creating a high-quality output audio signal. This is achieved by creating an external protective sound background, as well as through the implementation of the active noise reduction mode. The active noise reduction mode is based on measuring the noise level outside of the device using at least one external microphone. The sound background received from an external microphone acts as a primary acoustic wave, based on which a secondary audio signal is generated, inverse to the primary acoustic wave. The use of a secondary signal or combination of primary and secondary signals leads to the creation of destructive interference acting in the area surrounding the device, which results in significant noise reduction outside the device, resulting in a reduction in the imposition of external noise on the user's speech. Due to these actions, subscribers of the user will receive an audio signal of higher quality.

In passive mode, the device can be used as audio speakers, using external speakers and/or wired or wireless headphones.

The device of the invention is relevant for use in public places: airports, train stations, call centers, public transport, offices, schools, etc. It will minimize the noise created by talking people, improve the quality of communication, ensure confidentiality of conversation and significantly improve the comfort of communication.

1. The wireless confidential device for voice communication comprising an ergonomically shaped housing with a flange shaped for covering the area around a user mouth, the housing comprises at least one microphone, transceiver, switch, sound absorbing means or a sound reducing means, wherein the said housing comprises a front portion, side portions and a back portion, the flange is arranged on the inner surface of the front part of the housing, the device includes a wired or wireless headset, at least one headphone connected with the mobile communication means, and arranged to complement the passive muffling methods of speech by active muffling methods of speech and noise reduction methods.

2. The wireless confidential device for voice communication according to claim 1, wherein the front part of the housing is made detachable.

3. The wireless confidential device for voice communication according to claim 1, wherein the flange on the inner surface of the front part of the housing is made removable and from an elastic sound-absorbing material or a material, that reduces sound.

4. The wireless confidential device for voice communication according to claim 1, wherein the flange material is neutral to the user's skin and provides a comfortable fit to the skin.

5. The wireless confidential device for voice communication according to claim 1, wherein the housing comprises at least one external microphone connected to the transceiver and configured to measure the noise level outside the device.

6. The wireless confidential device for voice communication according to claim 1, wherein the control of the modes of active speech reduction and noise reduction modes is carried out by means of special software loaded into mobile communication means.
